(19) United States
(12) Patent Application Publication
(10) Pub. No.: US 2005/0052954 A1
(43) Pub. Date: Mar. 10, 2005

(54) Event and relationship timepiece

(76) Inventors: Martin Riedi, Miami, FL (US); Christian Valderrama, Miami, FL (US)

Correspondence Address: MALLOY & MALLOY, P.A., 2800 S.W. Third Avenue, Historic Coral Way, Miami, FL, 33129, US

(21) Appl. No.: 10/656,030

(22) Filed: Sep. 5, 2003

(51) Int. Cl. G04C 1/00

(52) U.S. Cl. 368/110

(57) ABSTRACT

A timepiece structured to record and display the elapsed time from at least one specific event to the current time including a processor having a chronographic application structured to record the elapsed time on a continuous basis. The processor also includes a restrictive designation application structured to restrict resetting of the timepiece, or the chronographic application associated therewith, by a user thereof, with a different event. A memory capability is included for storing one or more original input times of associated events, wherein the timepiece and/or the chronographic application can be reset only by entry through a restrictive access to the memory capability, such as may be accomplished by the an authorized processing facility, rather than the user or owner of the timepiece. The elapsed time of a selected specific event is thereby “permanently” and continuously recorded for display by restricting the ability to reset or stop the timepiece.

### BACKGROUND OF THE INVENTION

1. Field of the Invention

This invention is directed to a timepiece structured to record and display elapsed time from an original input time of a specific event continuously through the current time period. Reliable and consistent monitoring of the elapsed time is facilitated by preventing a user or owner of the timepiece from arbitrarily resetting the timepiece to monitor a new or different event or from changing the original input time of one or more first selected specific events.

2. Description of the Related Art

The use of a timepiece to measure the elapsed time from a specific occurrence to a current time period or other related event are extremely well known and have been used in different forms for many years. Perhaps the most obvious or practical example of such timepieces is the conventional “stopwatch” frequently used in athletic events. As such, the stopwatch is activated at the beginning of the event and continued until the event ends or the event is interrupted one or more times. By way of example, an athlete's speed in a race is frequently determined by utilizing a stopwatch, activated at the start of the race and operated continuously until one or more participants cross the finish line. The stopwatch will thereby record and display the time elapsed for one or more participants to complete the race. Similarly, in team sports field clocks, as well as other electronic timing devices are utilized to display, both to the participants and spectators alike, the allotted time remaining for playing the event. Therefore, the elapsed time as recorded and displayed represents the continuously diminishing time period left for continuance the sporting event.

Therefore, it is clear that a variety of different timepieces are available to measure elapsed time of athletic and other events of the type set forth above. Timepieces also exist which are intended to display elapsed time or otherwise serve as chronographic reminders of specific personal events which may have occurred in the past. Such past events may be directly related to achievements, honors, marriages, graduations, professional achievements, births and on a more somber note, the passing of loved ones. Utilization of elapsed time, chronological devices, while popular in certain segments of today's modern society are not used by many due to the belief that their operation is inherently complex and/or unreliable. In addition, the average person may be satisfied by a simple reference to a printed hard copy or electronic displayed calendar. However, these latter devices are unable to maintain a continuous record of the elapsed time and are used to provide a reminder on a yearly, monthly, weekly or other predetermined periodic basis.

Also, conventional electronic or mechanical timepieces of the type set forth above are frequently structured to facilitate a resetting of the timepiece in order that it may be used repeatedly to measure the elapsed time of different events. Further, elapsed time monitoring devices of the type mentioned above may be specifically structured to maintain a current, accurate time for display, while also having the capabilities of recording one or more elapsed times for a variety of different events, at least on a temporary basis. Therefore, the development and commercial availability of a timepiece structured to record and display time which has elapsed from an original date of occurrence to the current time on a continuous and reliable basis would be accepted by the public at large in that the disadvantages and problems associated with past clocks, watches, etc. of this type would be overcome.

Further, a user of such an improved timepiece could be assured of the consistent, reliable and permanent nature of the operation thereof, thereby making the timepiece more adaptable for recording and displaying the elapsed time of more personal events such as the beginning of a relationship, the date of a marriage, the birth of one or more children and/or the passing of a loved one. Accordingly, one operative feature which may be incorporated in an improved timepiece of the type set forth herein would be preventing of the user or owner from “arbitrarily” resetting the timepiece to monitor the elapsed time of different events. In other words, the user or operator would be prevented from changing his or her mind, such as upon the ending of a personal relationship.

Therefore, an improved timepiece of the type described would be reliable and “permanent” to the extent that one or more specific events selected for monitoring could not be easily changed, altered or stopped. Further, an improved timepiece for measuring the elapsed time of one or more specific events should also have the capability of a limited access memory, wherein additional specific events could be entered into the timepiece only by an original manufacturer or other designated facility in order to further assure the permanent nature of the elapsed time monitoring activities of the timepiece.

### SUMMARY OF THE INVENTION

The present invention is directed to a timepiece structured to determine, record and display elapsed time from the first occurrence of one or more specific events continuously up to and including the current time. As such, events of a more personal nature such as personal relationships, marriages, engagements, child births, etc. would be permanently monitored in terms of the elapsed time from the beginning of the event up through and including the current time on a substantially perpetual basis. The permanent nature of the operation of the timepiece in accomplishing the monitoring of the elapsed time is further facilitated, as will be explained in greater detail hereinafter, by preventing a user or owner of the timepiece from “resetting” the chronographic operation thereof in order to change the original input date of a specific event or the specific event itself.

Most individuals have known or been directly associated with numerous events wherein the reminder of the beginning of the event brings back fond memories. Similarly, many individuals may have encountered situations where a specific event such as personal relationships, marriages, etc. was initially believed to be terminated but which was continued for any of a variety of different reasons. As such, the timepiece of the present invention would assure the permanent nature of recording and monitoring the elapsed time from the occurrence of a preselected event by preventing the user or operator from arbitrarily “resetting” the timepiece thereby destroying a record of the elapsed time on a sometimes arbitrarily basis. As will further be explained herein after, while such structural and operational features of the timepiece restrict the ability to reset the timepiece, provisions for resetting or “re-programing” the timepiece under certain anticipated circumstances are made available. Further, stopping operation of the timepiece would also be made purposely difficult in order that the monitoring, recording and display of the elapsed time of the specific event can be maintained on a “permanent” basis.

Therefore, the timepiece of the present invention comprises a housing having a display assembly structured to display the elapsed time from at least the occurrence or beginning of one specific event to and through the current time. The display assembly is more specifically structured to automatically or selectively present the elapsed time in at least one but preferably a plurality of different time intervals of common denomination such as minutes, hours, days, weeks, months, years, etc. The timepiece, in it's various embodiments, also includes integrated, preferably digital operative components.

More specifically, the timepiece of the present invention comprises a digitally operative processor programed and/or structured to include specific applications which are responsive and collectively operative to accomplish the consistent, reliable and continuous recording of the elapsed time. The specific event can be initially entered into the processor by means of an original input time. The processor includes a chronographic application determinative of the elapsed time, once activated, from the original input time, on a continuous basis through the current time period. As such, an activation assembly is cooperatively structured with the processor and more specifically with the chronographic application to selectively instigate the monitoring or recording of the elapsed time from the original input time.

Another structural and operative feature of the timepiece of the present invention includes the processor comprising a restrictive designation application structured to restrict a “resetting” of the chronographic application. As such, the user will not be able to “unilaterally” begin monitoring the elapsed time of a different specific event without a predetermined administrative processing of the operative components of the timepiece, as will be more fully explained herein after.

Other structural features include the processor having a memory capability initially provided to have a limited access. Moreover, one or more original input times stored within the memory capability would not be readily accessed without “defeating” the limited access features associated with the memory. This also assures a permanent nature of elapsed time recording capabilities of the timepiece by only allowing a processing facility, such as the original manufacturer or distributor, to access and reestablish the original input time. By way of example only, if a user or owner of the timepiece inadvertently or purposely stops the operation thereof, resulting in the elapsed time no longer being continuously monitored, the memory capability of the processor will store the original input time of the preselected specific event. Return of the timepiece, or at least the processor facility associated therewith, to the original distributor or manufacturer will allow access to the original input time of a given specific event, stored in the memory. Upon re-entry of the original input time, the chronographic application will again establish an accurate and reliable elapsed time period as well as continue to monitor the elapsed time as originally intended.

Also, while the timepiece of the present invention may be electrically powered using a conventional power source and/or an auxiliary, emergency power source, situations may arise where the power source fails. In such an event, the memory capability is further structured to retain the original input time as well as facilitate operation of the processor to continue to monitor, on a continuous basis, the amount of elapsed time therefrom during the power failure. As a result, restoration of the power will result in the timepiece displaying the accurate elapsed time since the original input time, as if the power failure had not occurred.

Other operative and structural features adding to the versatility of the timepiece of the present invention would be the ability to add additional specific events, such as the birth of additional children, for continuous and concurrent monitoring with the original specific event, such as the marriage of a couple or the birth of a first child. Therefore, the timepiece of the present invention overcomes many of the disadvantages and problems associated with elapsed time monitoring devices thereby making such devices more desirable to a larger segment of the consuming public.

These and other objects, features and advantages of the present invention will become more clear when the drawings as well as the detailed description, are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front view in schematic form of a housing including a display and control assembly associated therewith.

FIG. 2 is a schematic representation in block diagram form of a processor, its various applications and operative components associated with the functioning of the timepiece of the present invention.

FIG. 3 is a schematic representation in block diagram form representing structural and functional features of the timepiece of the present invention.

FIG. 4 is a schematic view in block diagram form further representing the structural and operational features of the timepiece of the present invention.

FIG. 5 is a front view in schematic form of yet another preferred embodiment of a housing including a variation of a display and control assembly associated therewith, which differs from the preferred embodiment of FIG. 1.

Like reference numerals refer to like parts throughout the several views of the drawings.

### DETAILED DESCRIPTION OF THE PREFERRED EMBODIMENT

As shown in the accompanying drawings, the present invention is directed to a timepiece generally indicated as 10 structured to determine and display elapsed time from the beginning of at least one specific event up to and including the current time. As such, the elapsed time from preferably one, but possibly a plurality of various preselected events, may be continuously monitored and visually reviewed. Further, the timepiece 10 of the present invention represents a substantially “permanent” means for monitoring and reviewing the elapsed time in that it is structured to not be arbitrarily and/or easily turned off. In addition and as will be explained in greater detail herein after, the structural and operative features of the timepiece 10 restrict resetting thereof by an owner or operator. Therefore, while the timepiece 10 does include a restrictive reset ability, such resetting or “reprogramming” of the timepiece must occur in a deliberate fashion preferably by the original manufacturer, distributor or other “processing facility” equipt and authorized to preform the resetting feature.

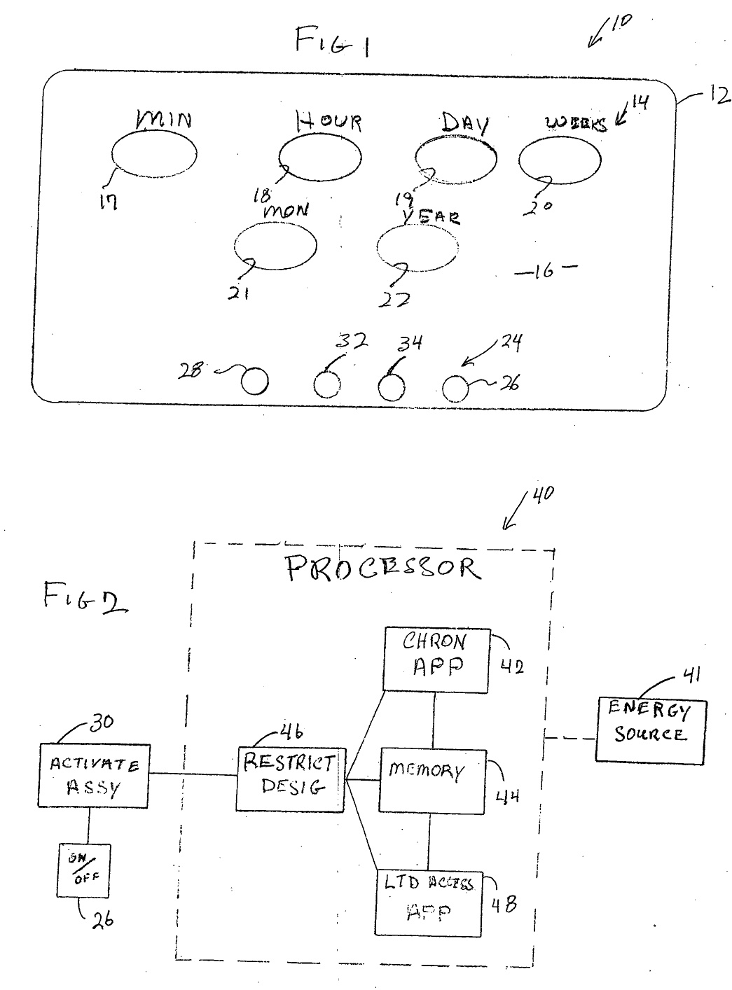

More specifically, the timepiece 10 includes a housing 12 having a display assembly generally indicated as 14 disposed on at least one observable face or surface 16 thereof. In at least one preferred embodiment, the display assembly 14 comprises a plurality of display windows or observation areas 17 through 22 which individually display one of a plurality of conventional time intervals such as minute, hour, day, week, month, year, etc. Accordingly, the plurality of windows 17 through 22 and their respective time intervals collectively represent the complete amount of time that has elapsed from the beginning or first occurrence of a specific, selected event. It should be noted that a number of windows or observation areas 17 through 22 may be fewer or greater in number than that represented in FIG. 1. With reference to both FIGS. 1 and 5, different preferred embodiments of the housing 12 and 12′ can be structured to display different time intervals such as only minutes and hours and/or days and years. In each of the preferred embodiments of FIGS. 1 and 5, the display assembly informs a user of the elapsed time concurrently and continuously by displaying a number of different time intervals as indicated.

More specifically, in the preferred embodiment of FIG. 5 a lesser number of display windows or areas 23 and 25 are included on the face 16′ of the housing 12′. By way of example only, these two display windows may be initially intended to display a pair of specific time segments, such as day and year. However, upon a manipulation of the control assembly 24, to be described in greater detail hereinafter, the time segments in each of the display windows 23 and 25 may change to a different or alternate pair of time segments, such as minutes and hours. Accordingly, while a lesser number of display windows or areas 23 and 25 are present on the face 16′ when compared to the embodiment of FIG. 1, a significant number of time segments may be displayed on a “selective” basis rather than automatically as demonstrated in FIG. 1. The selective changing of the time segment display is manually controlled by manipulation of the control members 32, 34 or other specialized control members which may or may not be considered a part of the control assembly 24.

In addition, the housing 12 includes a control assembly generally indicated as 24. The control assembly may include a plurality of buttons, knobs, or like control members which independently serve to operate, actuate or otherwise facilitate the function and control of the timepiece 10. As such, the control assembly may include an on/off button or switch 26 and an activating control button 28 operatively associated with an activation assembly 30. One or more additional control buttons or knobs 32 and 34 connected to other operative components are included in the control assembly 24 for the further functioning or control of the timepiece 10. By way of example only, one or more of the additional control members 32 or 34 may be used to initially set the timepiece 10 to the start or first occurrence time of a specific event such as, but not limited to, the beginning of a relationship, the date of birth, the time of marriage, etc.

As will be explained herein, the timepiece assembly of the present invention is structured to be a permanent, continuous monitoring of elapsed time from the beginning or first occurrence of a specific event. Accordingly, a resetting of the timepiece to vary the pre-chosen specific event or the original input time marking the beginning of that event is significantly restricted. However, one exception to this restriction would be allowing a user predetermined time “adjustment time” from the initial setting of the timepiece. The adjustment time may be used to reset the timepiece so as to modify the original input time by way of providing a more accurate time. By way of example only, a user may initially select an original input time of October 10 at 12:00 noon to be set into the timepiece as the beginning of a chosen event. Within a short period of time the user may then determine that the “correct” beginning or first occurrence of the chosen event was actually some four hours later or on October 10 at 4:00 p.m. The timepiece 10 including the processor 40 and the control assembly 24 now will be cooperatively structured to allow adjustment of the original input time by permitting it to be reset. However, the adjustment or resetting must be accomplished within a predetermined period of time of, by way of example only, 24 hours. Therefore, within the 24 hour period immediately following the initial setting of the original input time into the timepiece assembly 10, the user will be allowed to reset or adjust the original input time to more accurately represent the beginning or first occurrence of the chosen event. Such resetting can also occur by manipulation of the control members 32 or 34 as set forth above.

It should be further noted that the timepiece 10 and its various operative components may or may not be structured to serve as a conventional timepiece displaying to a user or operator the current time, such as in hours and minutes, by means of a digital display in the windows or observation areas 21 and 22 OR 23 and 25. This conventional functioning may or may not be available once the user of the timepiece 10 decided to select a specific event from which the elapsed time is to be recorded and displayed. Therefore, the on/off switch as at 26 could first be manipulated to initially activate the timepiece 10, wherein the other control or setting knobs 32 and/or 34 may be manipulated to initially set the timepiece 10 to the current time in terms of hours or minutes. Subsequently, when a specific event had been selected, the activation assembly could be operated, through manipulation of the control knob 28, as well as the one or more setting knobs 32 and 34 so as to enter the beginning or first occurrence of the selected specific event. Once the specific event was entered, the timepiece 10 could be structured to no longer function as a conventional timepiece for displaying the current time period, as desired by the user.

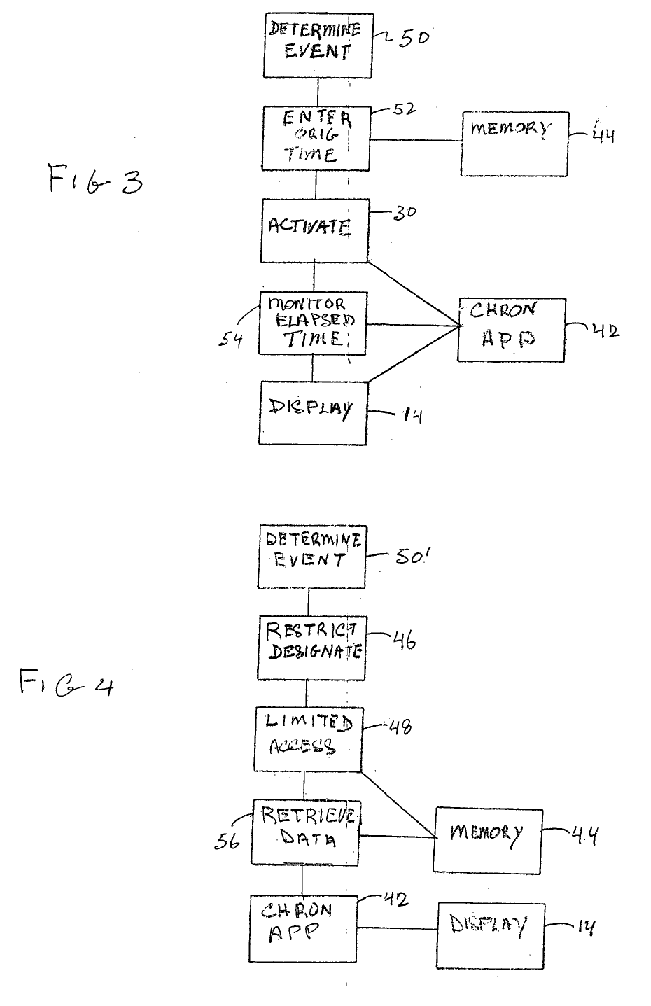

With specific reference to FIGS. 2 through 4, the timepiece 10 of the present invention would incorporate a processor generally indicated as 40. The processor and other operative components of the timepiece 10 may be powered by either a self contained or external source of energy, schematically represented as 41. Moreover, the processor 40 is preprogrammed and otherwise structured to include a variety of applications which facilitate the functioning of the timepiece 10 in the intended manner. More specifically, the processor preferably includes a chronographic application 42 structured to record and monitor the elapsed time of the specific event from the entered beginning or first occurrence of the specific event. For purposes of clarity, the beginning or first occurrence of a selected specific event will hereinafter be represented as the “original input time”. As such the chronographic application 42 would record and facilitate the display, by means of the display assembly 14 or 14′, of the amount of time that has elapsed from the original input date of a specific event to and through the current time period. The above mentioned activation assembly 30 is operatively interconnected to the chronographic application 42 so as to facilitate the entry of the original input time of the selected specific event. In addition, the activation assembly and the chronographic application may be cooperatively structured and operatively interconnected to instigate the continuous monitoring by the chronographic application of the elapsed time from the specific event and more specifically from the original input time, to and through the current time.

In addition to the above and as will be explained in greater detail herein after, the processor 40 further includes memory capability as at 44 which stores the original input time entered as the beginning or first occurrence of the selected specific event. Moreover, the original input time stored by the memory facilitates a restoration of the original input time to the chronographic application 42 if and when it is found necessary to “reprogram” or reset the chronographic application or in the event of a power failure. Such reprogramming or “resetting” of the timepiece 10 is prohibited except under restricted circumstances in order to assure the permanency of the functioning of the timepiece 10. A user or owner of the timepiece 10 may thereby consistently depend on the reliability of maintaining an accurate record of the elapsed time from the original input date to the current time of any selected specific event.

However, if the user or owner wants to reset the timepiece 10 upon the happening of a special occurrence, such as giving birth to twins, the beginning of a new relationship, etc. resetting of the timepiece 10 is possible but preferably not by the owner or operator on an arbitrary basis. Accordingly, the processor 40 further comprises a restrictive designation application 46 operative with and specifically structured to restrict resetting of the chronographic application to any “other” original input time once the chronographic application 42 has been initially activated and the elapsed time of the first selected specific event is being monitored. In more simplistic terms, the owner or operator will be prevented from changing his or her mind at least to the extent of selecting a new specific event or changing the original input time thereof. As set forth above, a preferred exception to this is the ability to “modify” or adjust the original input time within a predetermined time period in order to provide a “more accurate” original input time. Again, this assures the permanency and reliability of the timepiece 10 in accurately displaying the quantity of elapsed time from the initial input time of the first selected specific event. The restrictive designation application 46 is thereby specifically structured to at least initially limit selection of the specific event to a single happening or occurrence.

Additional preferred embodiments of the timepiece 10 may include structural and operational features which allow more than one specific event to be initially entered into one or more chronographic applications 42. By way of example, the timepiece 10 may be initially structured to allow two or more specific events to be secured or programmed into the processor 40, whereby the elapsed time from the original input time of each of the selected specific events will be recorded and/or selectively displayed by means of a display assembly 14 or more than one display assembly 14, associated with the housing 12.

Further restrictive measures incorporated within the processor 40 intended to prevent the resetting of the timepiece 10 by a user or owner includes a limited access application 48. The limited access application 48 is structured to restrict access to the memory capability 44 and any data or original input time stored therein. Moreover, even though one or more original input times, dependent upon the preferred embodiment of the present invention utilized, may be stored in the memory capability 44, access thereto for purposes of resetting or re-establishing continued operation of the chronographic application 42 is restricted. However, in certain specific situations, as generally referred to above, the owner or user may be desirous of entering a new original input time for different or additional specific event, such as by the birth of a second child, the birth of twins, etc. as set forth above. To accomplish this procedure the timepiece 10 and/or the processor 40, preferably in the form of a microprocessor chip or like electronic structure, is returned to an original manufacturer, distributor or other processing facility to accomplish the deliberate resetting of the timepiece 10. The authorized processing facility (not represented in the Figures for purposes of clarity) will thereby be allowed to enter the memory capability 44 by “defeating” the limited access application 48. Such defeat of the limited access application 48 may be accomplished by a built in access code or a variety of other operational techniques and procedures well known in the processor art.

The operational and structural features of the timepiece 10 of the present invention is represented in FIG. 3, wherein an owner or operator first determines a specific event for which the elapsed time is to be monitored, as at 50. In cooperation with the activation assembly 30, the original input time is entered as at 52 into the chronographic application 42, wherein the original input time is also stored in the memory capability 44, as discussed above. Activation of the timepiece 10 as at 30 serves to instigate monitoring of the elapsed time by the chronographic application 42 as at 54. The elapsed time, as monitored and recorded by the chronographic application 42 is then continuously displayed by the display assembly 14 or 14′ utilizing the one or more of the display or observation windows 17 through 22 of the preferred embodiment of FIG. 1 or the display windows 23 and 25 of the preferred embodiment of FIG. 5.

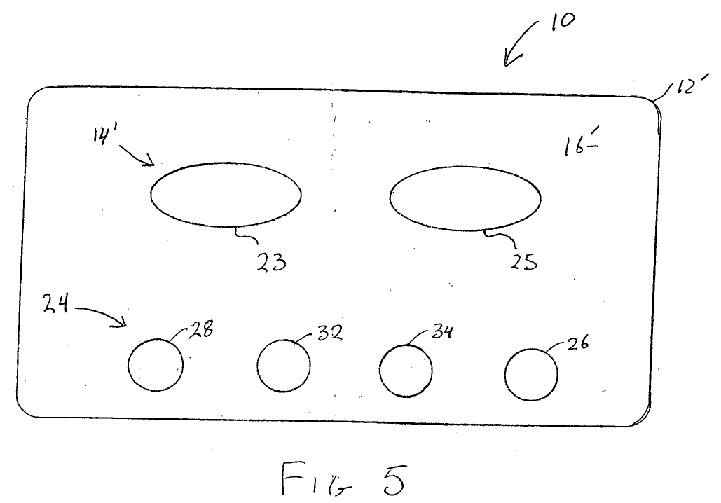

As emphasized above, the permanent nature and reliability of the timepiece 10 in monitoring, recording and displaying the elapsed time from the original input time of one or more specific events is assured by preventing the owner or operator from “arbitrarily” resetting the timepiece 10 or easily stopping it from functioning. However, when a resetting or reprogramming of the chronographic display 42 is desired purposes of changing first chosen “original event”, the timepiece 10 and/or the processor 40 may be delivered to a manufacturer, distributor or other control processing facility for resetting or reprogramming. Accordingly, as represented in FIG. 4, a specific event for which the chronographic display 42 is to be reprogrammed is determined as at 50′. The restrictive designation application 46 is “bypassed” by the facilities and procedures available at the processing facility. Similarly, the limited access application 48 is defeated by the aforementioned access code or other technique which allows access to the memory capability 44. Once the memory capability 44 is accessed, the original input times can be retrieved as at 56 and restored to the chronographic applications 42 or the processor can be restored or replaced so that a “new” specific event can be monitored. The chronographic application 42 can then be reactivated to initiate continuous monitoring, such as by operation of the activation assembly 30, wherein the monitored and/or recorded elapsed time will be displayed as at 14 or 14′ on housing 12 or 12′, respectively.

One exception to the requirement of returning the processor 40 and/or timepiece 10 to a central processing facility would be when the timepiece 10 or 10′ encounters a power failure. While the energy source 41 is intended to be representative of a conventional power source as well as an auxiliary or “emergency” power source, power failure may still occur. Upon such an occurrence, the memory capability 44 of the processor 40 is structured to retain the original input time and be operational with the chronographic application 42 such that no time is lost during the period of the power failure. When the power is restored, the processor 40 will be fully operative to continuously display an accurate elapsed time from the original input time preset or programed into the processor 40, as described above.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A timepiece structured to determine the elapsed time from a specific event, said timepiece comprising:
a) a housing including a display assembly structured to display elapsed time,
b) a processor including a chronographic application determinative of the elapsed time,
c) an activation assembly cooperatively structured with said processor to selectively instigate monitoring of the elapsed time from the specific event to the current time, and
d) said processor further comprising a restrictive designation application structured to at least initially limit selection of the specif event to a single occurrence.

2. A timepiece as recited in claim 1 wherein said display assembly is structured to display current elapsed time in at least one time interval.

3. A timepiece as recited in claim 2 wherein said display assembly is structured to display current elapsed time in a plurality of different time intervals.

4. A timepiece as recited in claim 2 wherein said display assembly is structured to display current elapsed time concurrently in a plurality of different time intervals.

5. A timepiece assembly as recited in claim 4 wherein said plurality of time intervals alternatively comprise two different pairs of time intervals.

6. A timepiece as recited in claim 1 wherein said restrictive designation application is structured to restrict resetting of said chronographic application.

7. A timepiece as recited in claim 6 wherein said processor comprises a memory capability structured to store an original input time of the specific event.

8. A timepiece as recited in claim 7 wherein said processor further comprises a limited access application structured to restrict access to said memory capability and any original input time stored therein.

9. A timepiece as recited in claim 8 wherein said memory capability is accessed and said original input time stored therein is accessed by defeat of said limited access application.

10. A timepiece as recited in claim 9 wherein said chronographic application is responsive to said defeat of said limited access application at least to the extent of being reset.

11. A timepiece as recited in claim 10 wherein said chronographic application is operable to determine current elapsed time subsequent to the resetting thereof to a corresponding original input time.

12. A timepiece as recited in claim 1 wherein said processor further comprises a memory capability structured to store an original input time of at least one specific event.

13. A timepiece as recited in claim 12 wherein said memory capability is further structured to store a plurality of original input times, each of said plurality of original input times associated with an occurrence of a different specific event.

14. A timepiece as recited in claim 12 wherein said restrictive designation application is structured to restrict resetting of said chronographic application to said original input time or a new input time subsequent to a predetermined adjustment time period and instigation of time monitoring by said chronographic application.

15. A timepiece as recited in claim 12 wherein said memory capability is operative to automatically restore said original input time to said chronographic application in the event of a power failure.

16. A timepiece structured to determine the elapsed time from at least one specific event, said timepiece comprising:
a) a housing including a display assembly structured to display elapsed time,
b) a processor including a chronographic application determinative of the elapsed time from the specific event to the current time,
c) said processor including a memory capability structured to store at least one original input time of an associated specific event,
d) an activation assembly operative with said chronographic application and structured to instigate continuous monitoring by said chronographic application of elapsed time from the specific event to the current time, and
e) said processor further comprising a restrictive designation application structured to initially limit selection of a predetermined number of specific events being monitored by said chronographic application.

17. A timepiece as recited in claim 16 wherein said restrictive designation application is structured to restrict resetting of said chronographic application.

18. A timepiece as recited in claim 17 wherein said restrictive designation application is structured to restrict resetting of said chronographic application by entry of an original input time for a specific event other than original input times associated with said predetermined numbers specific events.

19. A timepiece as recited in claim 16 wherein said restrictive designation application is structured to restrict entry of original input time for a specific event other than original input times associated with said predetermined number of specific events.

20. A timepiece as recited in claim 16 wherein said processor further comprises a limited access application structured to restrict access to said memory capability and an original input time of an associated specific event stored therein.

21. A timepiece as recited in claim 20 wherein said memory capability is accessed and said original input time is restored to said chronographic application by defeat of said limited access application.

22. A timepiece as recited in claim 16 wherein said display assembly is structured to display current elapsed time concurrently in a plurality of time intervals.

23. A timepiece as recited in claim 16 wherein said memory capability is operative to automatically restore said original input time to said chronographic application in the event of a power failure.

24. A timepiece structured to determine the elapsed time from at least one specific event, said timepiece comprising:
a) a housing including a display assembly structured to display elapsed time,
b) a processor including a chronographic application determinative of the elapsed time,
c) an activation assembly operative with said chronographic application and structured to instigate continuous monitoring by said chronographic application of elapsed time from the specific event to a current time, and
d) said processor further comprising a restrictive designation application structured to restrict resetting of said chronographic application to any original input time subsequent to instigation of elapsed time monitoring by said chronographic application.

25. A timepiece as recited in claim 24 wherein said processor further comprises a memory capability structured to store at least one original input time of an associated specific event.

26. A timepiece as recited in claim 25 wherein said processor further comprises a limited access application structured to restrict access to said memory capability and an original input time of an associated specific event stored therein.

27. A timepiece as recited in claim 26 wherein said memory capability is accessed and said original input time is restored to said chronographic application by defeat of said limited access application.
